(19) United States
(12) Patent Application Publication
(10) Pub. No.: US 2021/0200314 A1
(43) Pub. Date: Jul. 1, 2021

(54) TACTILE FEDBACK BY A LONGITUDINALLY MOVED MAGNETIC HAMMER

(71) Applicant: NANOPORT TECHNOLOGY INC., Markham (CA)

(72) Inventor: Timothy Jing Yin SZETO, Mississauga (CA)

(21) Appl. No.: 16/076,498

(22) PCT Filed: Feb. 10, 2017
(86) PCT No.: PCT/CA2017/050162

§ 371 Date: Jun. 10, 2019

Related U.S. Application Data
(60) Provisional application No. 62/313,398, filed on Mar. 25, 2016.
(60) Provisional application No. 62/294,871, filed on Feb. 12, 2016.

(51) Int. Cl. G06F 3/01; H01F 7/16; H01F 7/08; H01F 7/02

(52) U.S. Cl. CPC G06F 3/016; H01F 7/1615; G06F 3/041; H01F 7/0205; H01F 7/081

(57) ABSTRACT

The electronic device generally has a housing; a tactile input interface mounted to the housing; a tactile feedback actuator having a hammer path having two ends, with at least one of said two ends end being provided in the form of a stopper and a coil element fixed relative to the housing, and a magnetic hammer movable between the ends of the hammer path, the magnetic hammer having two opposite ends, each end of the magnetic hammer having a corresponding permanent magnet, the two permanent magnets having opposing polarities, the magnetic hammer being electromagnetically engageable by a magnetic field emitted upon activation of the coil element so as to be longitudinally moved along the hammer path to strike the stopper; and a controller housed within the housing and in communication with the tactile input interface and the tactile feedback actuator.

### FIELD

The improvements generally relate to the field of electronic devices and more particularly to tactile feedback actuators for use in electronic devices.

### BACKGROUND

Mechanical actuators have been used in electronic devices to provide tactile (a form of haptic) feedback. Such tactile feedback may be used, for example, to simulate the feel of a mechanical button when a user interacts with an interface without a mechanical button, e.g., a touch pad or a touchscreen.

An example of a tactile feedback actuator is described in United States Patent Publication US 2015/0349619. There thus remains room for improvement.

### SUMMARY

In accordance with one aspect, there is provided a tactile feedback actuator for providing a tactile feedback. The tactile feedback actuator has two stoppers delimiting two ends of a hammer path, with at least one stopper having a ferromagnetic portion, a hammer path guide and a coil element fixedly mounted relatively to one another, and a magnetic hammer having two opposite ends. Each end of the magnetic hammer has a corresponding permanent magnet. The two permanent magnets having opposing polarities. During use, the magnetic hammer is slidably engaged with the hammer path guide and electromagnetically engageable by a magnetic field emitted upon activation of the coil element so as to be longitudinally slid between the two stoppers and along the hammer path.

When the coil element is activated, the magnetic hammer can be moved along the magnetic hammer path towards a given one of the two stoppers until the magnetic hammer strikes the given stopper, which can create a different type of tactile feedback. When the coil element is not activated, however, the magnetic hammer can be maintained in a rest position via magnetic attraction between a corresponding one of the permanent magnets and the ferromagnetic portion of the at least one stopper.

In accordance with another aspect, there is provided an electronic device comprising: a housing; a tactile input interface mounted to the housing; a tactile feedback actuator having a hammer path having two ends, with at least one of said two ends end being provided in the form of a stopper and a coil element fixed relative to the housing, and a magnetic hammer movable between the ends of the hammer path, the magnetic hammer having two opposite ends, each end of the magnetic hammer having a corresponding permanent magnet, the two permanent magnets having opposing polarities, the magnetic hammer being electromagnetically engageable by a magnetic field emitted upon activation of the coil element so as to be longitudinally moved along the hammer path to strike the stopper; and a controller housed within the housing and in communication with the tactile input interface and the tactile feedback actuator.

In accordance with another aspect, there is provided a tactile feedback actuator having a hammer path having two ends, with at least one of said two ends being provided in the form of a stopper, and a coil element fixedly mounted relatively to the hammer path, and a magnetic hammer movable between the ends of the hammer path, the magnetic hammer having two opposite ends, each end of the magnetic hammer having a corresponding permanent magnet, the two permanent magnets having opposing polarities, the magnetic hammer being electromagnetically engageable by a magnetic field emitted upon activation of the coil element so as to be longitudinally moved along the hammer path to strike the at least one stopper.

In accordance with another aspect, there is provided a method of operating a tactile feedback actuator, the tactile feedback actuator having a hammer path having two ends, with at least one of said two ends being provided in the form of a stopper, and a coil element fixedly mounted relative to the stopper, and a magnetic hammer having two opposite ends and being slidably engaged with the hammer path guide, between the two ends, the method comprising: activating the coil element to accelerate the magnetic hammer towards the stopper, and for the magnetic hammer to then strike the stopper.

In accordance with another aspect, there is provided a method of operating a tactile feedback actuator, the tactile feedback actuator having a hammer path and a coil element fixed relative to one another, and a magnetic hammer having two opposite ends and being movable along the hammer path, the method comprising the steps of: a. activating the coil element in a first polarity to accelerate the magnetic hammer to a given velocity in a first direction along the hammer path towards one of two ends of the hammer path; b. activating the coil element in a second polarity to decelerate the magnetic hammer and to accelerate the magnetic hammer in a second direction opposite the first direction; c. activating the coil element in the first polarity to decelerate the magnetic hammer and to accelerate the magnetic hammer in the first direction; and d. repeating the steps b. and c. to generate vibrations.

In accordance with another aspect, there is provided an electronic device comprising: a housing; a tactile input interface each being mounted to the housing; a tactile feedback actuator having a hammer path and a coil element fixed relative to one another, and a magnetic hammer having two opposite ends and being movable along the hammer path; and a controller housed within the housing and in communication with the tactile input interface and the tactile feedback actuator, the controller being configured to activating the coil element with a first polarity to accelerate the magnetic hammer a given velocity in a first direction along the hammer path towards one of two ends of the hammer path; activating the coil element with a second polarity to decelerate the magnetic hammer and to accelerate the magnetic hammer in a second direction opposite the first direction; and repeating the steps of decelerating and accelerating to oscillate the magnetic hammer between the two ends of the hammer path.

In accordance with another aspect, there is provided a tactile feedback actuator having two stoppers delimiting two ends of a hammer path, with at least one stopper having a ferromagnetic portion, a hammer path guide and a coil element fixedly mounted relatively to one another, and a magnetic hammer having two opposite ends, each end of the magnetic hammer having a corresponding permanent magnet, the two permanent magnets having opposing polarities, the magnetic hammer being slidably engaged with the hammer path guide and electromagnetically engageable by a magnetic field emitted upon activation of the coil element so as to be longitudinally slid between the two stoppers and along the hammer path; whereby, when the coil element is not activated, the magnetic hammer being maintainable in a rest position via magnetic attraction between a corresponding one of the permanent magnets and the ferromagnetic portion one of the stoppers.

In accordance with another aspect, there is provided an electronic device comprising: a housing; a tactile input interface each being mounted to the housing; a tactile feedback actuator having two stoppers delimiting two ends of a hammer path, a hammer path guide and a coil element fixedly mounted relatively to the housing, and a magnetic hammer having two opposite ends, each end of the magnetic hammer having a corresponding permanent magnet, the two permanent magnets having opposing polarities, the magnetic hammer being slidably engaged with the hammer path guide and electromagnetically engageable by a magnetic field emitted upon activation of the coil element so as to be longitudinally slid between the two stoppers and along the hammer path; and a controller housed within the housing and in communication with the tactile input interface and the tactile feedback actuator.

In accordance with another aspect, there is provided a method of operating a tactile feedback actuator, the tactile feedback actuator having a hammer path guide, two stoppers and a coil element fixedly mounted relative to the hammer path guide, and a magnetic hammer having two opposite ends and being slidably engaged with the hammer path guide, between the two stoppers, the method comprising: activating the coil element to accelerate the magnetic hammer towards one of the two stoppers, and for the magnetic hammer to then strike the corresponding stopper.

In accordance with another aspect, there is provided an electronic device comprising: a housing; a tactile input interface each being mounted to the housing; a tactile feedback actuator having a hammer path guide, two stoppers and a coil element fixedly mounted relatively one another, and a magnetic hammer having two opposite ends and being slidably engaged with the hammer path guide, between the two stoppers; and a controller housed within the housing and in communication with the tactile input interface and the tactile feedback actuator, the controller being configured to activate the coil element to accelerate the magnetic hammer a given velocity towards one of the two stoppers, the magnetic hammer striking the one of the two stoppers at the given velocity thereby stopping the movement of the magnetic hammer.

In accordance with another aspect, there is provided a method of operating a tactile feedback actuator, the tactile feedback actuator having a hammer path guide and a coil element fixedly mounted relative to one another, and a magnetic hammer having two opposite ends and being slidably engaged with the hammer path guide and along a hammer path, the method comprising the steps of: a. activating the coil element in a first polarity to accelerate the magnetic hammer to a given velocity in a first direction along the hammer path towards one of two ends of the hammer path; b. activating the coil element in a second polarity to decelerate the magnetic hammer and to accelerate the magnetic hammer in a second direction opposite the first direction; c. activating the coil element in the first polarity to decelerate the magnetic hammer and to accelerate the magnetic hammer in the first direction; and d. repeating the steps b. and c. to generate vibrations.

In accordance with another aspect, there is provided an electronic device comprising: a housing; a tactile input interface each being mounted to the housing; a tactile feedback actuator having a hammer path guide and a coil element fixedly mounted relatively one another, and a magnetic hammer having two opposite ends and being slidably engaged with the hammer path guide and along a hammer path; and a controller housed within the housing and in communication with the tactile input interface and the tactile feedback actuator, the controller being configured to activating the coil element with a first polarity to accelerate the magnetic hammer a given velocity in a first direction along the hammer path towards one of two ends of the hammer path; activating the coil element with a second polarity to decelerate the magnetic hammer and to accelerate the magnetic hammer in a second direction opposite the first direction; and repeating the steps of decelerating and accelerating to oscillate the magnetic hammer between the two ends of the hammer path.

Many further features and combinations thereof concerning the present improvements will appear to those skilled in the art following a reading of the instant disclosure.

### DESCRIPTION OF THE FIGURES

In the figures,

FIG. 1 is a top plan view of an electronic device incorporating a tactile feedback actuator, exemplary of an embodiment;

FIG. 2A is a top plan view of an example of a tactile feedback actuator;

FIG. 2B is a cross-sectional view of the tactile feedback actuator taken along line 2B-2B of FIG. 2A;

FIG. 2C is a sectional view of the tactile feedback actuator taken along lines 2C-2C of FIG. 2B;

FIG. 2D is a sectional view of a tactile feedback actuator showing a permanent magnet being positioned so as to be repellable by a coil element towards a stopper;

FIG. 3 is a top plan view of a magnetic hammer of the tactile feedback actuator of FIG. 2A, showing exemplary magnetic field lines therearound;

FIG. 4A is a sectional view of a coil element of the tactile feedback actuator of FIG. 2A, showing exemplary magnetic field lines therearound when the coil element is activated in a first polarity;

FIG. 4B is a sectional view of a coil element of the tactile feedback actuator of FIG. 2A, showing exemplary magnetic field lines therearound when the coil element is activated in a second polarity opposite the first polarity;

FIG. 5A and FIG. 5B show cross sectional views of the tactile feedback actuator of FIG. 2A taken at different moments in time during a full swing to the left of the magnetic hammer;

FIG. 6A and FIG. 6B show cross sectional views of the tactile feedback actuator of FIG. 2A taken at different moments in time during a full swing to the right of the magnetic hammer;

FIG. 7 is a graph showing an exemplary periodic activation function usable to activate a coil element of a tactile feedback actuator to cause a magnetic hammer to move back and forth therealong;

FIG. 8 is a cross-sectional view of another example of a tactile feedback actuator having a coil element including two longitudinally spaced part coil units;

FIGS. 9A and 9B are cross-sectional views of the tactile feedback actuator of FIG. 8 where a magnetic hammer is maintained in a stable center position using two different activation polarities;

FIG. 10A and FIG. 10B are graphs showing exemplary activation functions for inducing a magnetic hammer of the tactile feedback actuator of FIG. 8 to perform a half swing;

FIG. 100 and FIG. 10D are graphs showing periodic versions of the graphs of FIG. 10A and FIG. 10B, respectively;

FIG. 11A and FIG. 11B are graphs showing periodic activation functions for inducing a magnetic hammer of the tactile feedback actuator of FIG. 8 to perform a full swing; and

FIG. 12 is a cross-sectional view of another example of a tactile feedback actuator including a magnetic hammer having ends with non-magnetic portions at a permanent magnet therebetween, in accordance with an embodiment.

### DETAILED DESCRIPTION

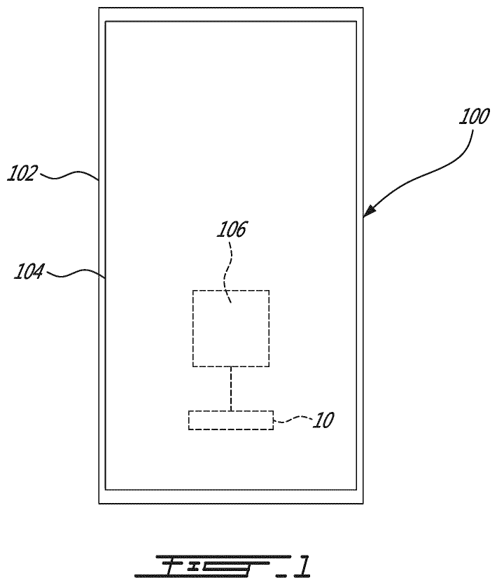

FIG. 1 shows an example of an actuator 10 that can be operated to provide tactile feedback.

As depicted, the actuator 10 can be included in a handheld electronic device 100 (e.g., a smartphone, a tablet, a remote control, etc.). The actuator 10 can also be used to provide vibration/buzzing functions in the electronic device 100, in lieu of a conventional vibration generator (e.g., a piezoelectric actuator).

The electronic device 100 generally has a housing 102 to which a tactile input interface 104 is provided. For instance, the tactile input interface 104 can be a touch-sensitive sensor or a pressure sensor (of capacitive or resistive types). The tactile input interface 104 can include a touch-screen display. As shown in this example, the housing 102 houses and encloses the actuator 10 and a controller 106. The controller 106 is in communication with the tactile input interface 104 and with the actuator 10. The controller 106 can be part of a computer of the electronic device 100 and/or be provided in the form of a separate micro-controller. It is noted that the electronic device 100 can include other electronic components such as the ones found in conventional electronic devices. An example of an electronic device incorporating a pressure-sensitive user interface is described in PCT/CA2015/051110.

The controller 106 can be used to operate the actuator 10. For instance, during use, the tactile input interface 104 can receive a touch by a user which causes the interface 104 to transmit a signal to the controller 106 which, in turn, operates the actuator 10 to provide a tactile feedback in response to the touch.

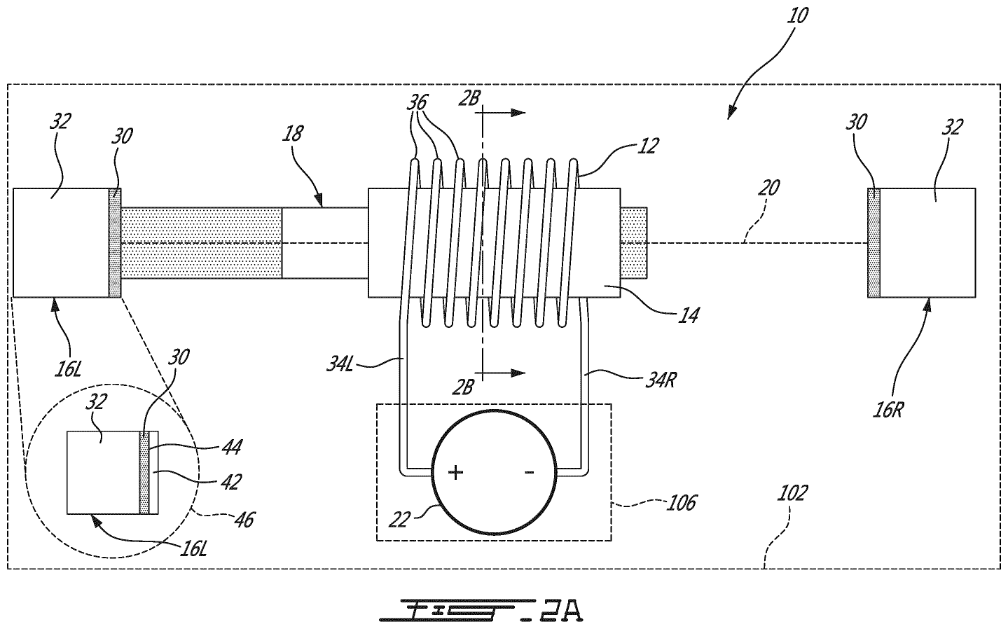

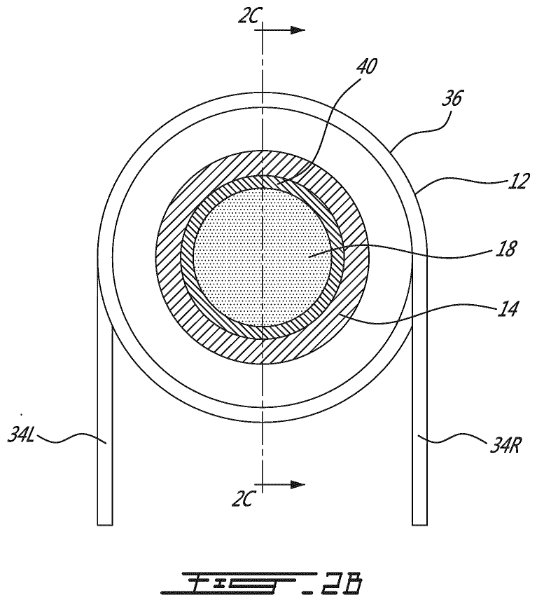

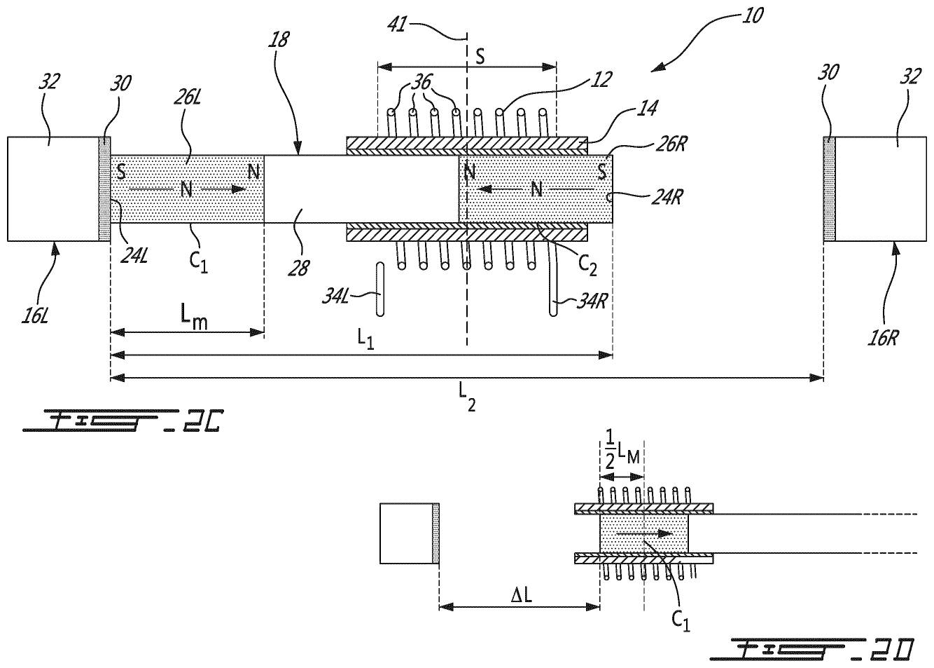

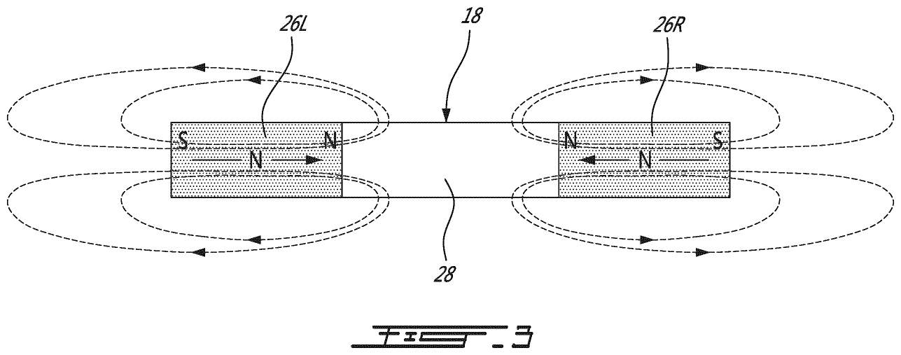

As can be appreciated, FIG. 2A is a top plan view of the actuator 10; FIG. 2B is a cross-sectional view of the actuator 10, taken along line 2B-2B of FIG. 2A; and FIG. 2C is a cross-sectional view of the actuator 10, taken along line 2C-2C of FIG. 2B.

As depicted, the actuator 10 includes a coil element 12, a hammer path guide 14 and two stoppers 16L,16R fixedly mounted relatively to the housing 102 and a magnetic hammer 18. The magnetic hammer 18 is slidably engaged with the coil element 12 via the hammer path guide 14 and electromagnetically engageable by a magnetic field emitted upon activation of the coil element 12 so as to be longitudinally slid between the two stoppers 16L,16R and along a hammer path 20 delimited by the two stoppers 16L,16R.

The coil element 12 is activatable by a signal source 22 and can be provided as part of the controller 106, as specifically shown in FIG. 2A.

For clarity, in this disclosure, it will be noted that reference numerals identified with the letter L will refer to elements shown at the left-hand side of the page whereas the letter R will refer to elements shown at the right-hand side of the page. For instance, the stopper 16L refers to a first one of the two stoppers and is shown at the left-hand side of the page. Similarly, the stopper 16R refers to a second one of the stoppers and is shown at the right-hand side of the page. This nomenclature will apply to other components of the tactile feedback actuator.

As best seen in FIG. 2C, the magnetic hammer 18 has two opposite ends 24L,24R. The end 24L of the magnetic hammer 18 is provided proximate to the stopper 16L and the end 24R of the magnetic hammer 18 is provided proximate to the stopper 16R.

Each end 24L,24R of the magnetic hammer 18 has a corresponding permanent magnet 26L,26R. For ease of understanding, north and south poles of such permanent magnets are identified with corresponding tags N or S. As will be described below, the two permanent magnets 26L,26R have opposing polarities such that their magnetic poles form a S-N-N-S arrangement or a N-S-S-N arrangement along the magnetic hammer 18. As it can be seen, the magnetic hammer 18 has a middle segment 28 separating the two permanent magnets 26L,26R. Each permanent magnet 26L,26R can include two or more permanent magnet units each sharing a similar polarity orientation. For instance, the permanent magnet 26L can include two permanent magnet units arranged such as that the north pole of one of the two permanent magnet units be abutted on a south pole of the other one of the permanent magnet units. Each permanent magnet 26L,26R can be made from a rare earth material, such as Neodymium-Iron-Boron (NdFeB), Samarium-cobalt, or from iron, nickel or suitable alloys. The middle segment 28 can be made from a ferromagnetic material or from any other suitable material.

As can be seen in this example, and more specifically in FIGS. 2A and 2C, the two stoppers 16L,16R each have a ferromagnetic portion 30 made integral thereto. Each stopper can be made in whole or in part of a ferromagnetic material (e.g., iron, nickel, cobalt, alloys thereof) so as to magnetically attract the magnetic hammer 18. In the illustrated embodiment, however, each of the two stoppers 16L,16R has a non-ferromagnetic portion 32 which is made integral to the ferromagnetic portion 30. In an alternate embodiment, only one of the two stoppers 16L,16R has such a ferromagnetic portion.

As it will be understood, when the coil element 12 is not activated, the magnetic hammer 18 remains in a corresponding one of two rest positions via magnetic attraction between a corresponding one of the permanent magnets 26L,26R and the ferromagnetic portion 30 of a corresponding one of the two stoppers 16L,16R.

The ferromagnetic portion 30 can be sized to be sufficiently large to maintain the magnetic hammer 18 at the rest position, but sufficiently small to allow the coil element 12 to induce the magnetic hammer 18 to move away from that rest position when desired. For instance, the ferromagnetic portion 30 is a steel plate.

The non-ferromagnetic portion 32 can be made of a non-ferromagnetic material (e.g., aluminium) such that it does not attract the magnetic hammer 18. The non-ferromagnetic portion 32 can be made of a material that transmits forces/vibrations imparted by the magnetic hammer 18 when striking any of the stoppers 16L,16R. Referring back to FIG. 2A, the stoppers 16L,16R, and more specifically their non-ferromagnetic portions 32, are fixedly mounted relatively to the housing 102 such as to mechanically couple the actuator 10 to the housing 102 of the electronic device to transmit forces/vibrations through such components. It is noted that if a stopper were to be made out only of a ferromagnetic material, the attraction between the magnetic hammer 18 and the stopper may be too strong for the coil element 12 to dislodge the magnetic hammer from a rest position.

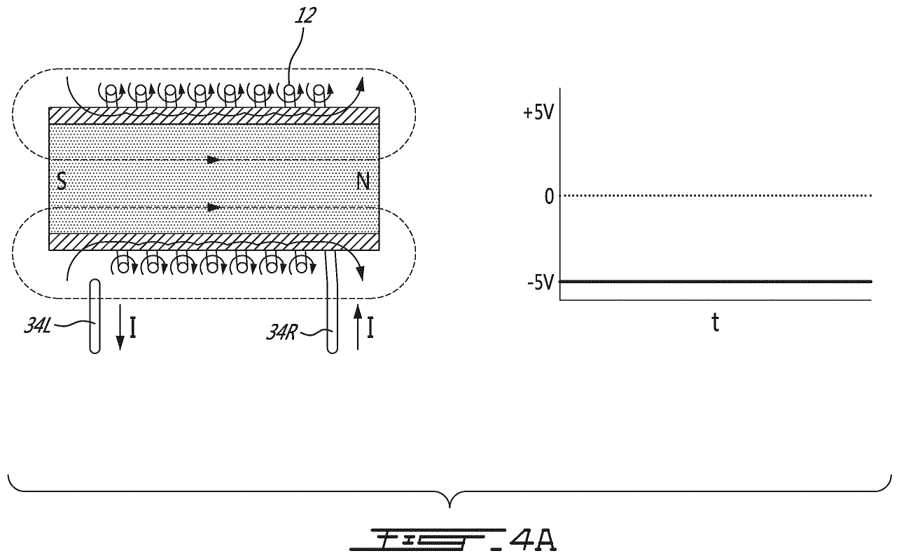

As shown in FIG. 3, the permanent magnets 26L,26R of the magnetic hammer 18 have opposing polarities and thus produce magnetic field lines such as the ones shown in this figure. For instance, as it can be seen, the north pole of each of the two permanent magnets 26L,26R is provided inwardly towards the middle segment 28 whereas the south pole of each of the two permanent magnets 26L,26R is provided outwardly from the middle segment 28.

The middle segment 28 is optional. For instance, in an embodiment where the middle segment 28 is omitted, the two permanent magnets 26L,26R are fastened together with sufficient strength to overcome the repelling forces between them.

Referring back to FIGS. 2A, 2B and 2C, the coil element 12 includes a plurality of turns or windings 36 of a conductive wire of a given diameter which wrap around the hammer path guide 14. The coil element 12 includes two wire ends 34L,34R to which is connected the signal source 22. In an embodiment, the coil element 12 includes 200-500 turns of 0.2 mm gauge insulated copper wire. In this embodiment, the hammer path guide is provided in the form of a sleeve having an outer diameter of about 3.2 mm and defining a hollow center cavity 40 with an inner diameter of about 3 mm, as best seen in FIG. 2B. As can be seen in this example, the magnetic hammer 18 is received in the hollow center cavity 40 and slides along the hollow center cavity 40 when the actuator 10 is operated. Any other suitable type of hammer path guide can be used.

In the embodiment shown, the permanent magnets 26L,26R have a cylindrical shape of a length Lₘ of 6 mm and of a diameter just under 3 mm (sized to fit through the hollow center cavity 40 of the hammer path guide 14). Still in this embodiment, the middle segment 28 has a cylindrical shape of a length of 7 mm and a diameter similar to the one of the permanent magnets 26L,26R. It is noted that the ferromagnetic portion can be a steel plate of a thickness of approximately 0.3-0.5 mm. It will be understood that persons of ordinary skill in the art can choose alternate dimensions for alternate embodiments.

Referring now to FIG. 2C, a permanent magnet length Lₘ, a magnetic hammer length L₁ and a hammer path length L₂ are designed so that, when the magnetic hammer 18 is in the rest position and one of the permanent magnets is abutted on one of the stoppers, the other one of the permanent magnets is positioned to as to be repellable by the coil element 12 towards the other one of the stoppers upon activation thereof. The coil element span S may also be relevant to consider.

In cases where the actuator 10 is symmetrical relative to a sagittal plane 41 of the actuator 10, a requirement in order for this to occur is that, in either rest position, the centers C₁,C₂ of the magnets 26L,26R stay on their respective side of the sagittal plane 41 of the coil element. To understand how to achieve this, referring now to FIG. 2D, the following relation: ½L₂−½Lₘ>ΔL should be verified. If the magnet 26L moves farther to the right than what is shown in FIG. 2D, the coil unit will not push it back to the left when the coil unit is activated.

Other suitable requirements may apply depending on the application, such as in cases where the coil element is not in the center of the hammer path, for instance.

The lengths of the permanent magnets 26L and 26R and of the middle segment 28 can be selected in dependence of the span S of windings 36 of the coil element 12. It is understood that the magnetic hammer 18 is positioned such that when the permanent magnet 26R abuts on the stopper 16R in the rest position, the permanent magnet 26L is positioned so as to be repellable by the coil element 12 towards the stopper 16L when it is activated. Similarly, when the magnetic hammer 18 is positioned such that the permanent magnet 26L abuts on the stopper 16L in the rest position, the permanent magnet 26R is positioned so as to be repelled by coil element 12 towards the stopper 16R when activated.

The magnetic field produced by the coil element 12 depends on the output of the signal source 22 (see FIG. 2A), which governs the direction and amplitude of current flow in the coil element 12. Of interest is the direction of the magnetic field lines of the coil element 12 and the effect on the magnetic hammer 18 as to whether it repels or attracts corresponding ones of the permanent magnets 26L,26R.

The coil element 12 can be activated by applying a given voltage V to the wire ends 34L,34R via the signal source 22. When activated, the coil element 12 forms an electromagnet having a given magnetic polarity with north (N) and south (S) poles at opposing sides of the coil element 12. This given magnetic polarity can be inverted by inverting the voltage V applied to the wire ends 34L,34R.

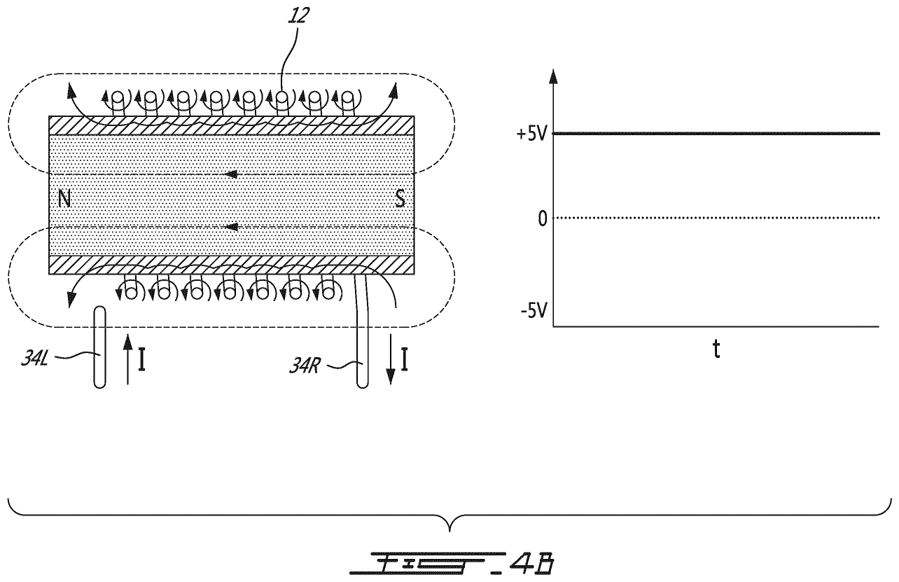

For instance, FIG. 4A shows that a given voltage of 5 V is applied to the coil element 12 whereas FIG. 4B shows that a given voltage of −5 V is applied to the coil element 12. In other words, changing the polarity of the voltage applied by the signal source is equivalent to inverting the flow direction of the electrical current I along the conductive wire of the coil element 12, and to inverting the polarity of the electromagnet, as shown by the upwards and downwards arrows near wire ends 34L,34R shown in FIGS. 4A and 4B.

For ease of reading, in the following paragraphs, the activation of the coil element 12 as shown in FIG. 4A can be referred to as “activation with a first polarity” whereas the activation of the coil element 12 as shown in FIG. 4B can be referred to as “activation with a second polarity”. The first polarity being opposite to that of the second polarity.

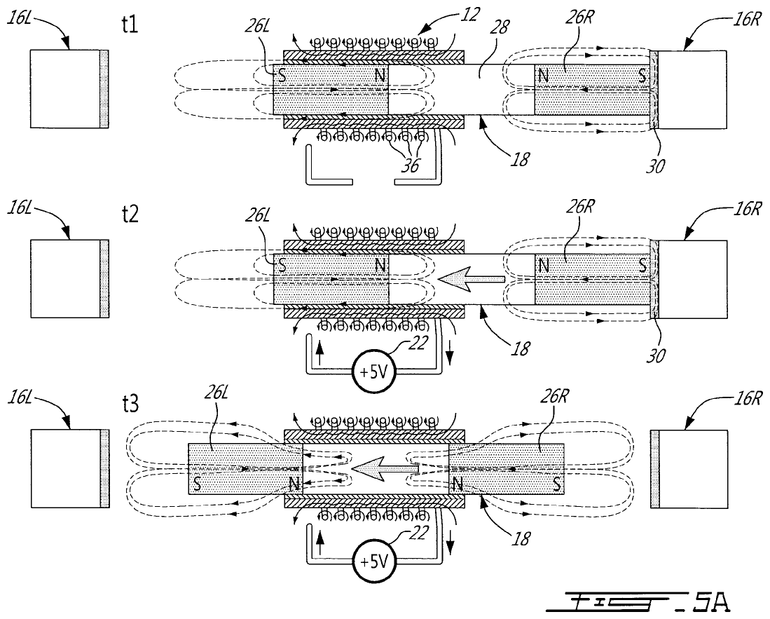

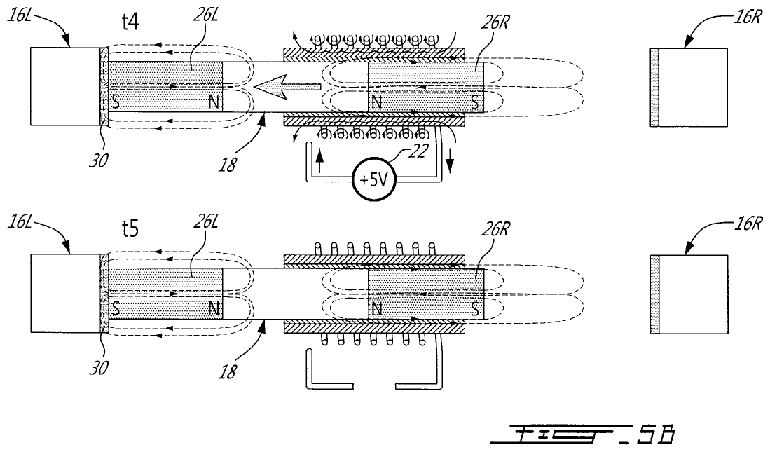

FIGS. 5A and 5B show an example of a first movement sequence of the magnetic hammer 18 (referred to as “a full swing”) beginning initially at a rest position abutting on the stopper 16R, and then moving leftwards towards the stopper 16L, in response to the activation of the coil element 12 with a first polarity, e.g., +5 V.

More specifically, FIGS. 5A and 5B include a snapshot at different moments in time t1 to t5 during the first movement sequence wherein t5>t4>t3>t2>t1. As shown in FIG. 5A at moment in time t1, the magnetic hammer 18 is in a rest position wherein the permanent magnet 26R is abutted on the stopper 16R. At this stage, the coil element 12 is not activated. There is a magnetic attraction between the permanent magnet 26R and the ferromagnetic portion 30 of the stopper 16R which maintains the magnetic hammer 18 in the rest position.

To initiate the movement of the magnetic hammer 18, the controller activates the coil element 12 by a voltage of the first polarity to the coil element 12 via the signal source 22 in a manner to generate an electromotive force between the coil element 12 and the hammer which overcomes the magnetic attraction between the permanent magnet 26R and the ferromagnetic portion 30. Such activation of the coil element 12 is maintained for the moments in time t2, t3 and t4.

As shown in FIG. 5A at moment in time t2, the activation of the coil element 12 causes acceleration of the magnetic hammer 18 from the rest position to a given velocity towards the stopper 16L. At this point, the activation of the coil element 12 repels the permanent magnet 26L towards the stopper 16L.

As shown in FIG. 5A at moment in time t3, the activation of the coil element 12 still causes the coil element 12 to repel the permanent magnet 26L towards the stopper 16L but also causes the coil element 12 to attract the permanent magnet 26R towards the coil element 12.

As shown in FIG. 5B at moment in time t4, the magnetic hammer 18 strikes the stopper 16L at the given velocity which stops the movement of the magnetic hammer 18.

As shown in FIG. 5B at moment in time t5, the magnetic hammer 18 is in a rest position wherein the permanent magnet 26L abuts the stopper 16L. At this stage, the coil element 12 can be de-activated. There is a magnetic attraction between the permanent magnet 26L and the ferromagnetic portion 30 of the stopper 16L which maintains the magnetic hammer 18 in the rest position.

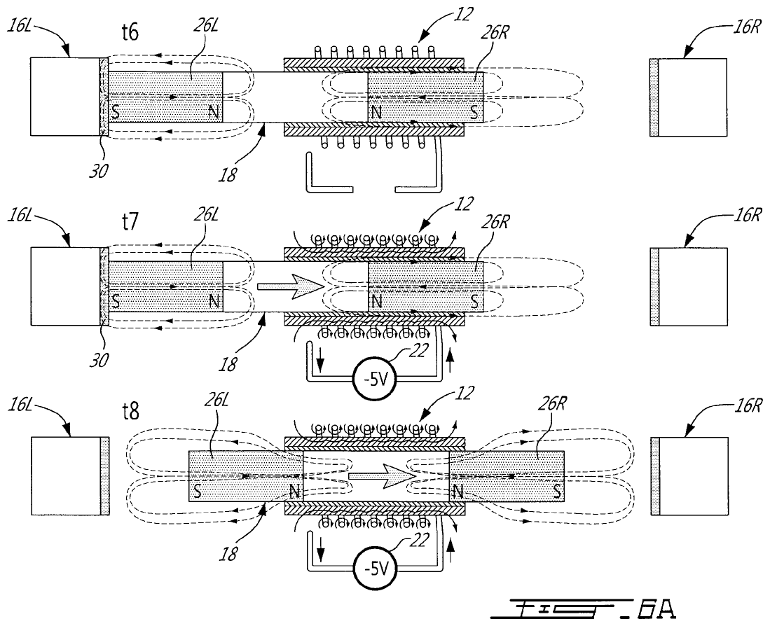

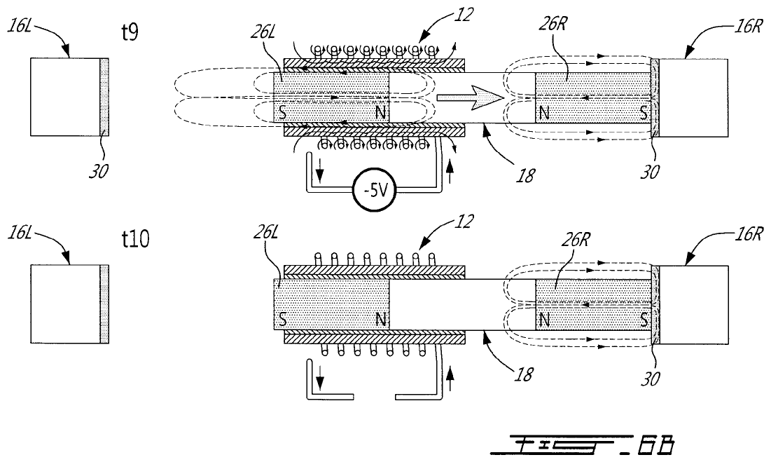

FIGS. 6A and 6B show an example of a second movement sequence of the magnetic hammer 18 (also referred to as “a full swing”) beginning initially at a rest position abutting on the stopper 16L and then moving rightwards towards the stopper 16R, in response to the activation of the coil element 12 with a second opposite polarity, e.g., −5 V.

More specifically, FIGS. 6A and 6B include a snapshot at different moments in time t6 to t10 during the second movement sequence wherein t10>t9>t8>t7>t6. As shown in FIG. 6A at moment in time t6, the magnetic hammer 18 is in a rest position wherein the permanent magnet 26L is abutted on the stopper 16L. At this stage, the coil element 12 can be deactivated. There is a magnetic attraction between the permanent magnet 26L and the ferromagnetic portion 30 of the stopper 16L which maintains the magnetic hammer 18 in the rest position.

To initiate the movement of the magnetic hammer 18, the controller activates the coil element 12 by a voltage of the second polarity to the coil element 12 via the signal source 22. Such activation of the coil element 12 is maintained for the moments in time t7, t8 and t9.

As shown in FIG. 6A at moment in time t7, the activation of the coil element 12 causes acceleration of the magnetic hammer 18 from the rest position to a given velocity towards the stopper 16R. At this point, the activation of the coil element 12 repels the permanent magnet 26R towards the stopper 16R.

As shown in FIG. 6A at moment in time t8, the activation of the coil element 12 still causes the coil element 12 to repel the permanent magnet 26R towards the stopper 16R but also causes the coil element 12 to attract the permanent magnet 26L towards the coil element 12.

As shown in FIG. 6B at moment in time t9, the magnetic hammer 18 strikes the stopper 16R at the given velocity which can stop the movement of the magnetic hammer 18.

As shown in FIG. 6B at moment in time t10, the magnetic hammer 18 is in a rest position wherein the permanent magnet 26R abuts the stopper 16R. At this stage, the coil element 12 can be deactivated. There is a magnetic attraction between the permanent magnet 26R and the ferromagnetic portion 30 of the stopper 16R which can maintain the magnetic hammer 18 in the rest position.

It is noted that the actuator 10 can be operated such that the first or second movement sequence each represent a movement sequence of a half cycle. It is contemplated that the actuator 10 can be operated such as to perform a movement sequence of a full cycle such that the magnetic hammer 18 travels from a given one of the stoppers towards the other stopper and travels back towards the given one of the stoppers, as shown in FIGS. 5 and 6 during moments in time t1 to t10. The magnetic hammer 18 will thus travel from a first rest position to a second rest position during a full swing of the magnetic hammer 18.

More specifically, the actuator 10 can be operated to perform a movement sequence of a full cycle by activating the coil element 12 with a voltage of a first polarity until the magnetic hammer 18 travels from a given stopper to another stopper and by subsequently activating the coil element 12 with a voltage of a second polarity until the magnetic hammer 18 travels back to the given stopper. Such a movement would cause two successive strikes of the magnetic hammer 18, one strike against the stopper 16L and another strike against the stopper 16R, for instance, after which the movement of the hammer can be stopped.

Alternately, the controller can operate the actuator 10 such as to create a series of strikes of the magnetic hammer against the stoppers. This behavior can be used to create a vibration at the electronic device.

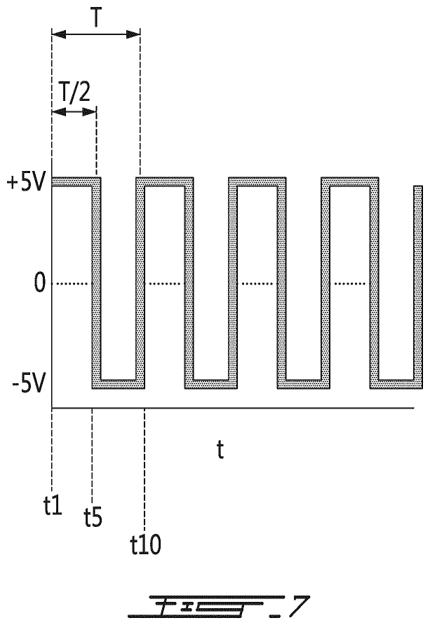

For instance, FIG. 7 shows an exemplary activation function representing the voltage that can be applied to the coil element 12 by the signal source over time so as to force the magnetic hammer 18 to oscillate between the two stoppers 16L,16R. Such an oscillating movement includes a plurality of half cycles (of half period T/2) or of full cycles (of period T) performed in a successive manner for a given amount of time. As depicted, the moments in time t1, t5 and t10 associated with the first and second movement sequences are shown in FIG. 7.

Optionally, the amplitude and/or duty cycle of the activation function applied by the signal source can be adjusted, e.g., using a software stored on a memory of the controller of the electronic device. For example, the amplitude and/or the period can be adjusted to change, respectively, the strength and/or the frequency of the vibration of the tactile feedback. Also, in an alternate embodiment, the amplitude and/or the duty cycle can be decreased to cause the magnetic hammer to oscillate between the two stoppers but without striking any of the two stoppers. It is noted that square waves can be generated easily, though the frequency and duty cycle can be controlled. To avoid an impact between the magnetic hammer and a given stopper, one can change the polarity of the coil unit at a moment in time before the magnetic hammer strikes the given stopper, and in sufficient time to decelerate the hammer. The precise timing can need to be tuned. In another embodiment, the effects of gravity are compensated using a position sensor (e.g., a Hall-effect sensor to detect the magnetic field as affected by the position of the hammer) provided as part of the actuator and/or as part of the electronic device. For instance, to provide feedback for controlling the coil unit (e.g., a PID controller or similar). A sensor based on current flowing through the coil is used in another embodiment, although it is harder to measure current than to measure the magnetic field.

The operation of the actuator can be used to generate tactile feedback at the electronic device, e.g., in response to a press of the tactile input interface. The strike of the magnetic hammer against any one of the stoppers, or both stoppers, can be audible, to simulate the sound of a button being depressed (e.g., a click or a tap).

Optionally, this sound can also be dampened on one or both stoppers. For instance, using a sheet 42 of shock-absorbing material on a surface 44 facing the hammer such that the feedback is only by felt by the user, and not heard, an example of which is shown at inset 46 in FIG. 2A. The shock-absorbing material can include soft foam material or any suitable material as deemed satisfactory by the skilled person.

In a scenario where the hammer is activated to give a single strike, or tap, to the stopper, the stopper which is struck by the hammer, and thus the side of the tap, can be selected by the controller based on various factors, such as the location of the user input on the tactile input interface. For instance, if one presses a virtual button on the left side of the tactile input interface of the electronic device, it may be preferred to strike the left stopper 26L. Conversely, if one presses a virtual button on the right side of the tactile input interface of the electronic device, it may be preferred to strike the right stopper.

FIG. 8 shows a sectional view of another example of an actuator 10′. As depicted, the actuator 10′ is substantially similar to the actuator 10 and includes a coil element 12′, the hammer path guide 14, the magnetic hammer 18 and the two stoppers 16L,16R.

However, in this embodiment, the coil element 12′ includes two coil units 12L,12R fixedly mounted relatively to the housing and longitudinally spaced from one another. The two coil units are activatable by a respective one of two independently controllable signal source 22L,22R that each can be part of the controller. The coil units 12L,12R can be wound in the same way relatively to one another such as to produce the same magnetic field (e.g., same direction and strength) in response to the same signal.

The magnetic hammer 18 is electromagnetically engageable by a magnetic field emitted upon activation of the two coil units so as to be one of longitudinally slid in full swings between first and second rest positions each associated with a corresponding one of two stoppers 16L,16R and along the hammer path 20. The magnetic hammer 18 can thus rest at one of these rest positions when the coil element 12′ is not activated.

When the first and second coil units 12L,12R are activated with a similar polarity, as shown by current flow direction arrows of FIG. 8, the first and second coil units 12L,12R collectively act as a single coil element such as described above. When so activated, each coil unit 12L,12R forms an electromagnet sharing a same polarity orientation (e.g., SNSN).

As it will be described in the following paragraphs, the use of first and second coil units 12L,12R can be activated to form a stable center position in the middle of the hammer path 20, and thus allows the magnetic hammer 18 to be ‘reset’ to the center when desired, moved in half-swings, e.g. from the center position to either stopper or vice-versa.

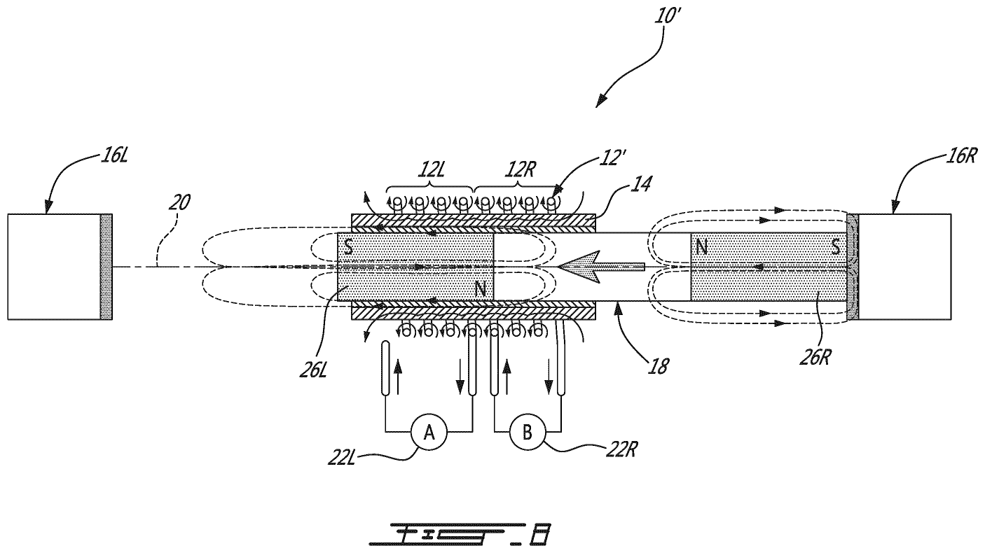

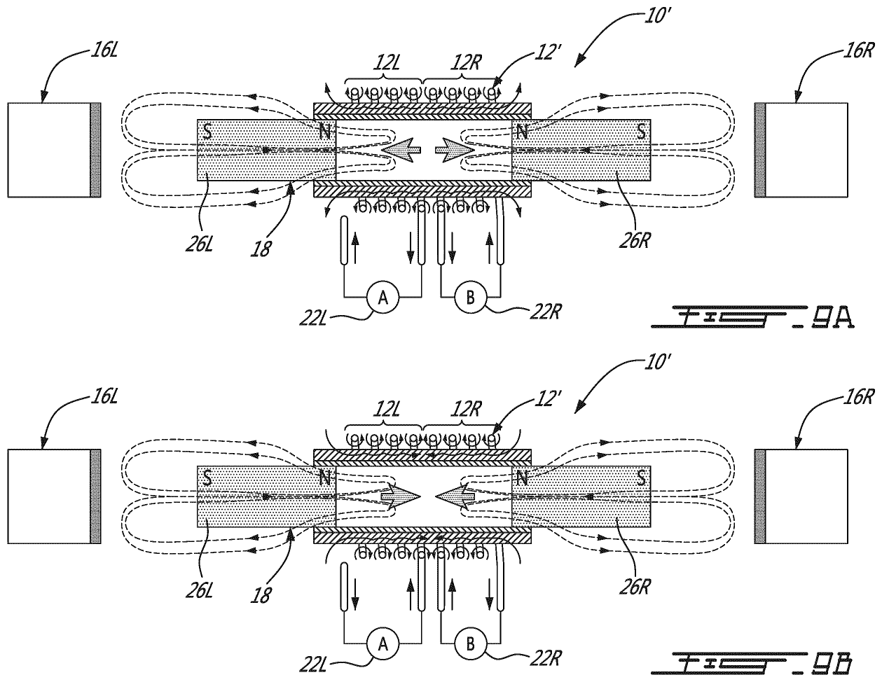

FIGS. 9A and 9B show the actuator 10′ wherein the magnetic hammer 18 is in such a stable center position. As will be understood, the magnetic hammer 18 can be positioned in the stable center position when the two coil units 12L,12R are both activated but with opposite polarities.

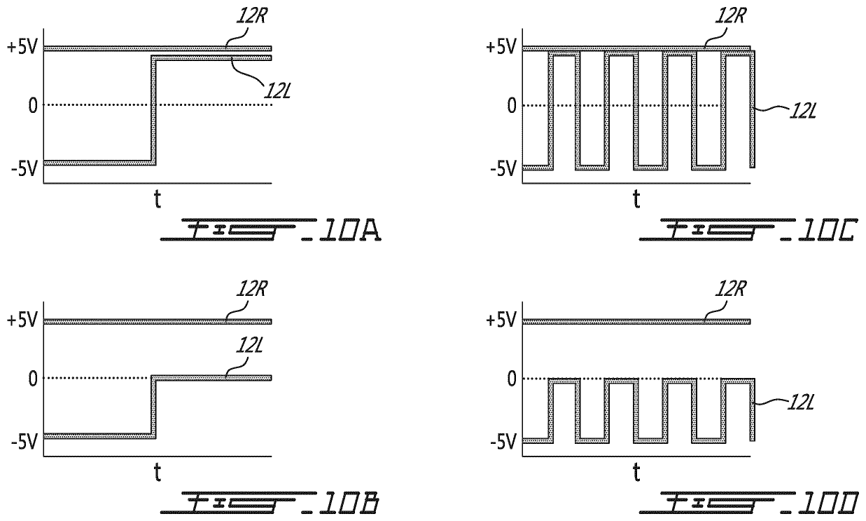

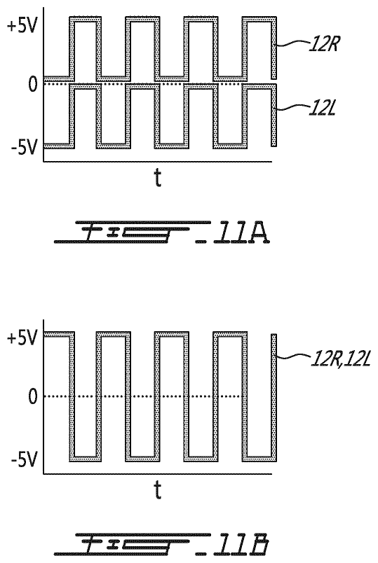

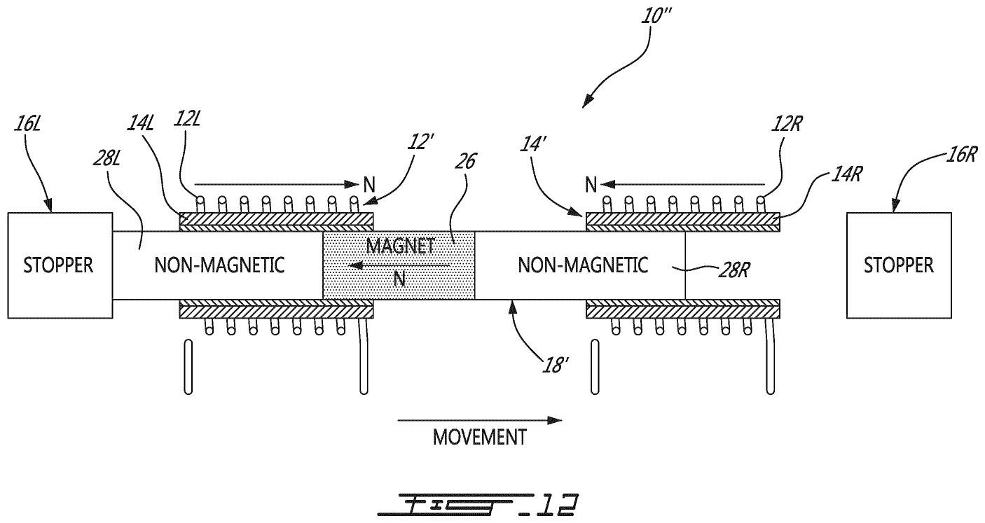

More specifically, in the activation functions shown in FIG. 10A, the coil unit 12L is shown to be activated in a first polarity of +5 V while the coil unit 12L is shown to be activated in a second polarity of −5 V such that the coil element 12′ outwardly repels each of the permanent magnets 26L,26R towards corresponding stoppers 16L,16R. In other words, the coil unit 12L repels the permanent magnet 26L towards the stopper 16L, and the coil unit 12R repels the permanent magnet 26R towards the stopper 16R. It will be understood that the labels “12L” and “12R” in FIGS. 10A-D do not refer to the corresponding coil units themselves but refer to the activation functions used to activate them.

In the example shown in FIG. 10B, the coil unit 12L is shown to be activated in a second polarity of −5 V while the coil unit 12R is shown to be activated in a first polarity of +5 V such that the coil element 12′ inwardly attracts each of the permanent magnets 26L,26R towards the center of the coil element 12′. In this case, the coil unit 12L attracts the permanent magnet 26L to the right, and the coil unit 12R attracts the permanent magnet 26R to the left.

Having a stable center position for the magnetic hammer 18 provides greater flexibility in controlling its movement. In the embodiment of actuator 10, the coil element 12 can be controlled to induce the magnetic hammer 18 to move from stopper to stopper, spanning the full length of the hammer path 20 of the actuator 10 in full swings. This is also possible in the embodiment of actuator 10′ (see FIG. 8). Additionally, in actuator 10′, the coil units 12L and 12R can be controlled to induce the magnetic hammer 18 to move in half-swings, i.e. from the stable center position to one of the stoppers.

For example, FIGS. 10A and 10B show activation functions of the coil units 12L,12R to induce a half swing. This can be achieved by maintaining one of the two coil units activated while either de-activating the other one of the two coil units or activating the other one of the two coil units in an opposite polarity. In this case of FIG. 12B, the force on the magnetic hammer 18 is reduced as only the coil unit 12R is powered to induce the magnetic hammer 18 to move towards the stopper 16L.

The activation functions of the coil units 12L,12R shown in either FIG. 10A or FIG. 10B can be repeated periodically to produce an oscillation of the magnetic hammer 18 such as shown in FIGS. 100 and 10D, causing a vibration or wobble of at the electronic device.

It is understood that the actuator 10′ can also be operated to provide full swing vibrations using the activation functions shown in FIG. 11A and FIG. 11B. Here again, it is noted that the labels “12L” and “12R” do not refer to the corresponding coil units themselves but refer to the activation functions used to activate them.

It is noted that the amplitude and/or the period can be decreased to cause the magnetic hammer to oscillate between the two stoppers but without striking any of the two stoppers. The position of the magnetic hammer 18 can be ‘reset’ to the center when desired, moved in half-swings, e.g. from the center position to either stopper or vice-versa.

FIG. 12 shows another example of an actuator 10″. In this embodiment, the actuator 10″ has the two stoppers 16L,16R delimiting two ends of the hammer path 20. The actuator 10″ includes a hammer path guide 14′ provided in the form of two longitudinally spaced apart guide elements 14L and 14R. The actuator 10″ includes the coil element 12′ having two longitudinally spaced apart coil units 12L,12R and a magnetic hammer 18′. The two stoppers 16L,16R, the hammer path guide 14′ and the coil element 12′ are fixedly mounted relatively to one another (e.g., to a housing of an electronic device).

In this embodiment, the magnetic hammer 18′ has two opposite ends with a permanent magnet 26 therebetween, each end of the magnetic hammer having a corresponding non-magnetic portion magnet 28L,28R. As it will be understood, the magnetic hammer 18′ is slidably engaged with the two guide elements 14L,14R and electromagnetically engageable by a magnetic field emitted upon activation of the coil units 12L,12R so as to be longitudinally slid between the two stoppers 16L,16R and along the hammer path 20. Depending on the application, the actuator 10″ can be operated to move the magnetic hammer 18′ in full swings or in halve swings. The magnetic hammer 18′ can be maintained in the stable center position when desired.

The tactile feedback actuators described herein can be incorporated into electronic devices incorporating pressure-sensitive user interfaces such as described in PCT/CA/051110. In this electronic device, inputs from pressure sensors (and optional touch sensors) are used in place of mechanical buttons (e.g., a power button). The actuators described herein may be activated in response to inputs received from such pressure/touch sensors. In an embodiment, the electronic device includes pressure-sensitive side edges. The actuators described herein may be operated to tap, vibrate, wobble, in response to input received from these side edges. The actuators may be activated to operate on a side corresponding to the particular side edge from which input is received.

As can be understood, the examples described above and illustrated are intended to be exemplary only. For instance, the tactile feedback actuator may not be symmetrical relative to its sagittal plane. The lengths and/or diameter of the permanent magnets may differ from one another. Moreover, it is noted that the two coil units can be configured, shaped and sized differently. In such cases, the signal that is used to activate each of the coil units may differ, not only in polarity, but also in amplitude. The scope is indicated by the appended claims.

1. An electronic device comprising:
a housing;
a tactile input interface mounted to the housing;
a tactile feedback actuator having
a hammer path having two ends, with at least one of said two ends end being provided in the form of a stopper and a coil element fixed relative to the housing, and
a magnetic hammer movable between the ends of the hammer path, the magnetic hammer having two opposite ends, each end of the magnetic hammer having a corresponding permanent magnet, the two permanent magnets having opposing polarities, the magnetic hammer being electromagnetically engageable by a magnetic field emitted upon activation of the coil element so as to be longitudinally moved along the hammer path to strike the stopper; and
a controller housed within the housing and in communication with the tactile input interface and the tactile feedback actuator.

2. The electronic device of claim 1 wherein the stopper has a ferromagnetic portion.

3. The electronic device of claim 1 comprising two stoppers delimiting the two ends of the hammer path.

4. The electronic device of claim 1 further comprising a hammer path guide in which the magnetic hammer is slidingly engaged.

5. The electronic device of claim 2 wherein the magnetic hammer remains in a rest position via magnetic attraction between a corresponding one of the permanent magnets and the ferromagnetic portion of the stopper when the coil element is not activated.

6. The electronic device of claim 1 wherein the magnetic hammer includes a middle segment separating the two permanent magnets of the magnetic hammer.

7. The electronic device of claim 6 wherein the middle segment is made of a ferromagnetic material.

8. A tactile feedback actuator having a hammer path having two ends, with at least one of said two ends being provided in the form of a stopper, and a coil element fixedly mounted relatively to the hammer path, and a magnetic hammer movable between the ends of the hammer path, the magnetic hammer having two opposite ends, each end of the magnetic hammer having a corresponding permanent magnet, the two permanent magnets having opposing polarities, the magnetic hammer being electromagnetically engageable by a magnetic field emitted upon activation of the coil element so as to be longitudinally moved along the hammer path to strike the at least one stopper.

9. The tactile feedback actuator of claim 8 wherein the at least one stopper has a ferromagnetic portion.

10. The tactile feedback actuator of claim 8 further comprising two stoppers delimiting the two ends of the hammer path.

11. The tactile feedback actuator of claim 8 further comprising a hammer path guide in which the magnetic hammer is slidingly engaged.

12. The tactile feedback actuator of claim 8 wherein the magnetic hammer includes a middle segment separating the two permanent magnets of the magnetic hammer.

13. The tactile feedback actuator of claim 12 wherein the middle segment is made of a ferromagnetic material.

14. The tactile feedback actuator of claim 8 wherein the at least one stopper has a layer of shock-absorbing material provided on a surface facing the magnetic hammer.

15-40. (canceled)

41. A method of operating a tactile feedback actuator, the tactile feedback actuator having a hammer path guide, two stoppers and a coil element fixedly mounted relative to the hammer path guide, and a magnetic hammer having two opposite ends and being slidably engaged with the hammer path guide, between the two stoppers, the method comprising:
activating the coil element to accelerate the magnetic hammer towards one of the two stoppers, and for the magnetic hammer to then strike the corresponding stopper.

42. The method of claim 41 wherein each end of the magnetic hammer has a corresponding permanent magnet, the two permanent magnets having opposing polarities and wherein said activating includes activating the coil element in a first polarity to emit a magnetic field causing repelling of one of the two permanent magnets towards the one of the two stoppers and attracting of the other one of the two permanent magnets towards the one of the two stoppers.

43. The method of claim 42 further comprising activating the coil element in a second opposite polarity to accelerate the magnetic hammer towards the other one of the two stoppers, and for the magnetic hammer to then strike the corresponding stopper.

44. The method of claim 41 wherein at least the one of the two stoppers has a ferromagnetic portion, the method further comprising, after said striking, maintaining the magnetic hammer abutted on the ferromagnetic portion of the stopper by magnetic attraction.

45. The method of claim 41 wherein the coil element includes at least two coil units fixedly longitudinally spaced from one another, the method further comprising activating a first one of the two coil units in a first polarity and activating a second one of the two coil units in a second polarity opposite the first polarity.

46. The method of claim 45 further comprising maintaining one of the two coil units activated while one of de-activating the other one of the two coil units and activating the other one of the two coil units in an opposite polarity.

47-52. (canceled)
